(19) United States
(12) Patent Application Publication
(10) Pub. No.: US 2014/0293297 A1
(43) Pub. Date: Oct. 2, 2014

(54) LABEL PRODUCTION APPARATUS AND LABEL PRODUCTION METHOD

(71) Applicant: SEIKO EPSON CORPORATION, Tokyo (JP)

(72) Inventor: Atsushi NAGAHARA, Azumino-shi (JP)

(73) Assignee: SEIKO EPSON CORPORATION, Tokyo (JP)

(21) Appl. No.: 14/223,690

(22) Filed: Mar. 24, 2014

(30) Foreign Application Priority Data
Mar. 28, 2013 (JP) 2013-068829

(51) Int. Cl. G06K 15/02; B41J 11/66; B41J 25/20; B41J 3/407

(52) U.S. Cl. CPC G06K 15/024; B41J 3/4075; B41J 11/66; B41J 25/20
USPC 358/1.6

(57) ABSTRACT

A label production apparatus includes: a printing unit configured to print, using image data for generation of a label image, a plurality of label images on a print target medium; a test unit configured to test each of the label images printed on the print target medium; and a controller for controlling the printing unit and the test unit. In the stated label production apparatus, the controller adds a mark including identification information of each label image to the image data so as to make the printing unit print the label image as well as the mark corresponding to the label image, and generates linkage data in which related are a test result of the label image by the test unit and the identification information of the label image to each other.

### BACKGROUND

1. Technical Field

The present invention relates to label production apparatuses and label production methods.

2. Related Art

For example, label production apparatuses configured to form images (label images) such as pictures, figures, symbols (characters), bar codes, and the like on a print target medium in which a mount, an adhesive layer, and a base material are laminated in sequence are well known. After the label images have been printed on the print target medium, a portion of the base material (and adhesive layer) where the label images are printed is cut. After the cutting, an unnecessary portion, that is, a portion other than the label image is separated from the mount (hereinafter, this separation is also called “unused portion removal” or “scrap removal”).

Such a label production apparatus is proposed that includes a test unit for testing label images that have been printed on a medium. In this case, by cutting only non-defective label images, it is possible to remove defectively printed label images together with an unnecessary portion of the medium. Another label production apparatus is also proposed in which a label including a “poor quality identification code” is pasted, after having detected a print defect, to a portion corresponding to the detected print defect (for example, see JP-A-2008-239316).

However, in the above label production apparatuses, a device for the cutting (post-process device) and a device for the printing (print device) are not configured together in an integrated manner in some case. In such case, it has been difficult to determine whether a label image is non-defective or defective at a time when the label is to be cut.

### SUMMARY

An advantage of some aspects of the invention is to provide a label production apparatus and a label production method that are able to easily determine whether a label image is non-defective or defective.

A label production apparatus according to an aspect of the invention includes: a printing unit configured to print, using image data for generation of a label image, a plurality of the label images on a print target medium; a test unit configured to test each of the label images printed on the print target medium; and a controller for controlling the printing unit and the test unit. Further, in the stated label production apparatus, the controller adds a mark including identification information of each label image to the image data so as to make the printing unit print the label image as well as the mark corresponding to the label image, and generates linkage data in which related are a test result of the label image by the test unit and the identification information of the label image to each other.

Other aspects of the invention will be clarified hereinafter through descriptions of this specification and the accompanying drawings.

### BRIEF DESCRIPTION OF THE DRAWINGS

The invention will be described with reference to the accompanying drawings, wherein like numbers reference like elements.

FIG. 1 is a block diagram illustrating a configuration of a label production apparatus.

FIG. 2 is a diagram illustrating a schematic configuration of a print device.

FIG. 3 is a cross-sectional view illustrating a configuration of roll paper.

FIG. 4 is a descriptive diagram illustrating a state in which unused portion removal is being carried out.

FIG. 5 is a flowchart illustrating a label image print operation of the print device.

FIG. 6 is a descriptive diagram of data obtained in a print job according to an embodiment of the invention.

FIG. 7 is a descriptive diagram of a QR code that is added to image data.

FIG. 8 is a descriptive diagram of image data to which QR codes are added.

FIG. 9 is a descriptive diagram of a print data generation process.

FIG. 10 illustrates diagrams of test results.

FIG. 11 is a flowchart for describing operation of a post-process device.

FIGS. 12A and 12B are descriptive diagrams of cut path data of defective printing.

FIG. 13 is a flowchart for describing a cutting process.

FIG. 14 is a diagram illustrating an example of label images printed by the print device.

FIG. 15 is a diagram illustrating a state after cutting and unused portion removal have been performed on the images shown in FIG. 14 by the post-process device.

FIG. 16 is a flowchart for describing a cutting process operation of the post-process device according to a second embodiment of the invention.

### DESCRIPTION OF EXEMPLARY EMBODIMENTS

### Outline

At least the following will be clarified through the descriptions of this specification and the drawings.

A label production apparatus including the following constituent elements will be clarified: that is, a printing unit configured to print, using image data for generation of a label image, a plurality of the label images on a print target medium; a test unit configured to test each of the label images printed on the print target medium; and a controller for controlling the printing unit and the test unit. Further, in the stated label production apparatus, the controller adds a mark including identification information of each label image to the image data so as to make the printing unit print the label image as well as the mark corresponding to the label image, and generates linkage data in which related are a test result of the label image by the test unit and the identification information of the label image to each other.

According to this label production apparatus, it is possible to easily determine whether a printed label image is non-defective or defective.

It is preferable in the above label production apparatus that the print target medium include a first base material having a print surface, a second base material, and an adhesive layer interposed between the first base material and the second base material; moreover, it is preferable that the above label production apparatus further include a post-process unit for cutting the first base material, and that the post-process unit, in accordance with the linkage data, cut a portion of the first base material where the label image is printed without any print defect that has been detected whereas do not cut a portion of the first base material where the label image is printed with a print defect that has been detected.

According to this label production apparatus, a defectively printed label image can be separated together with an unnecessary portion, that is, a portion other than the label image.

In the above label production apparatus, it is preferable that the print target medium include the first base material having the print surface, the second base material, and the adhesive layer interposed between the first base material and the second base material, the controller store the linkage date in a data storage region of a server which is communicably connected via networks, and the linkage data be used when a portion of the first base material of the print target material where the label image is formed is cut.

According to this label production apparatus, it is possible to cut the first base material in accordance with a test result regardless of the position where a device that carries out the post-process is arranged.

Such a label production apparatus will be clarified that has a post-process unit configured to cut, of a print target medium including a first base material having a print surface, a second base material, and an adhesive layer interposed between the first and second base materials, a portion of the first base material where a label image is printed. In the stated label production apparatus, a plurality of the label images are printed on the print target medium while a mark including identification information of each label image is added to each of the label images and printed together with the label image; further, the post-process unit, based on linkage data in which a test result of each of the label images and the identification information thereof are related to each other, cuts a portion of the first base material where the label image is printed without any print defect that has been detected whereas does not cut a portion of the first base material where the label image is printed with a print defect that has been detected.

According to this label production apparatus, it is possible to determine with ease whether the label image is non-defective or defective.

In the above label production apparatus, it is preferable that the post-process unit obtain the linkage data from a data storage region in a server communicably connected via networks.

According to this label production apparatus, it is possible to cut the first base material in accordance with a test result regardless of the positions where devices configured to perform the printing and testing are arranged.

A label production method including the following processes will be clarified: that is, the method includes printing a plurality of label images on a print target medium, using image data for generation of the label image, and adding a mark including identification information of each of the label images to each of the label images while relating each mark to each of the label images so as to print the label image with the mark being added; testing each of the label images printed on the print target medium; and generating linkage data in which related are a test result of each of the label images by the testing and the identification information of each of the label images.

### First Embodiment

An embodiment of the invention is given below while exemplifying a label production apparatus (hereinafter, referred to as “label production apparatus 1”) configured to print images using an ink jet technique.

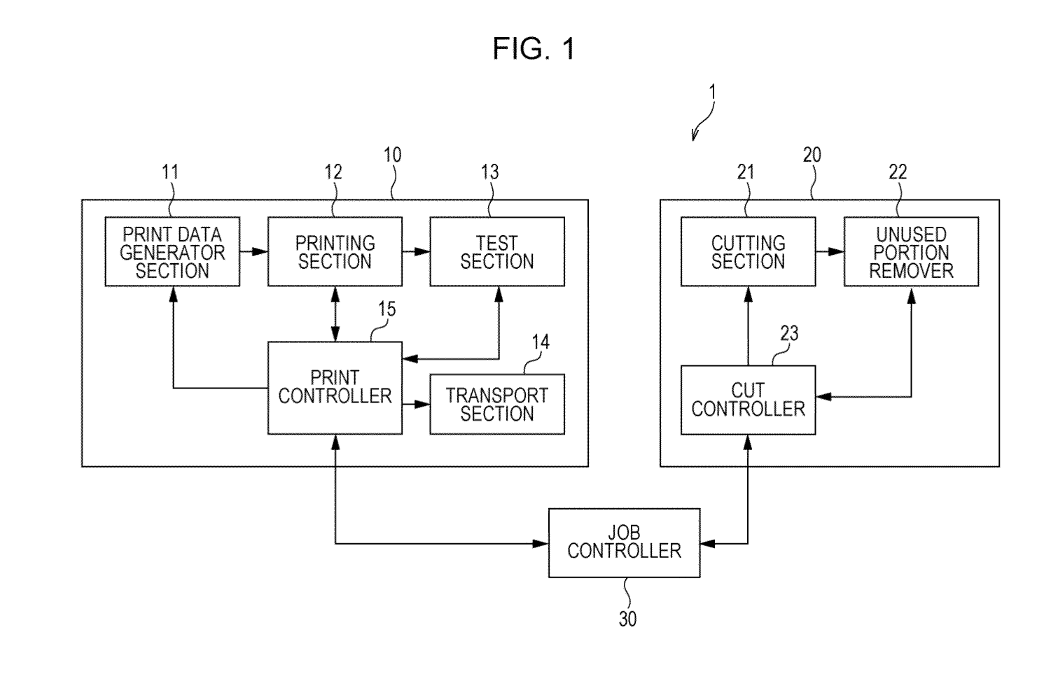

FIG. 1 is a block diagram illustrating a configuration of the label production apparatus 1. As shown in FIG. 1, the label production apparatus 1 includes a print device 10, a post-process device 20, and a job controller 30.

The print device 10 is configured to print images (label images) on a print target medium. As will be described later, the print device 10 of this embodiment is so configured as to test the printed label images as well.

The post-process device 20 cuts a portion of the print target medium where the label image is printed, and further carries out a removing process of an unnecessary portion (“unused portion removal” to be explained later).

The job controller 30 is connected with the print device 10 and the post-process device 20, respectively, in a communicable manner so as to control the print device 10 and the post-process device 20 to produce the labels. The job controller 30 acquires a print job from an input device (not shown). As the print job, data of an image to be printed, data for cutting, and so on are inputted. Based on the print job, the job controller 30 controls the print device 10 and the post-process device 20, respectively, to produce the labels.

### Configuration of Print Device 10

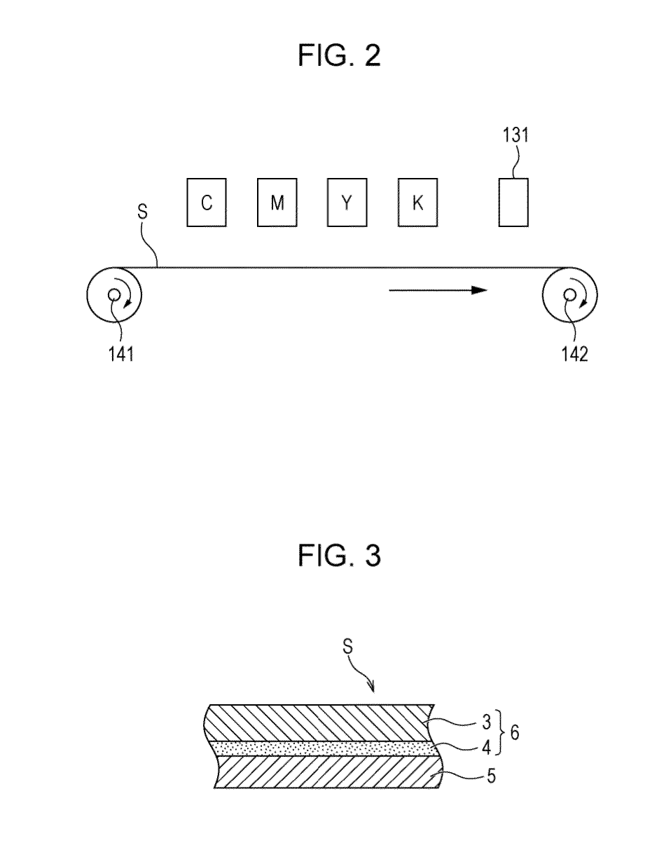

Hereinafter, a configuration of the print device 10 will be described with reference to FIG. 1 and FIG. 2. FIG. 2 is a diagram illustrating a schematic configuration of the print device 10.

In this embodiment, paper that is wound in roll form (hereinafter, referred to as “roll paper S” (continuous paper)) is used as an example of a medium (which corresponds to the print target medium) on which images (label images) are printed. FIG. 3 is a cross-sectional view illustrating a configuration of the roll paper S of this embodiment. As shown in FIG. 3, the roll paper S is configured of three layers including a base material 3 (which corresponds to the first base material), a mount 5 (which corresponds to the second base material), and an adhesive layer 4 interposed between the base material 3 and the mount 5. One surface of the base material 3 (surface on the opposite side to the adhesive layer 4) is a print surface on which label images are printed. The base material 3 and the adhesive layer 4 constitute a seal member 6.

As shown in FIG. 1, the print device 10 includes a print data generator section 11, a printing section 12, a test section 13, a transport section 14, and a print controller 15.

The print data generator section 11 generates print data based on the image data of the print job.

The printing section 12 is a section that forms (prints) a label image on the roll paper S using the print data. Note that the printing section 12 of this embodiment is a line printer including a plurality of heads which are so disposed as to face the roll paper S. To be more specific, as shown in FIG. 2, the printer has four heads including a cyan ink head C for discharging cyan ink, a magenta ink head M for discharging magenta ink, a yellow ink head Y for discharging yellow ink, and a black ink head K for discharging black ink. These four heads are disposed in series at constant intervals in the order of the cyan ink head C, magenta ink head M, yellow ink head Y, and black ink head K from the upstream side in a transport direction.

A nozzle row where a plurality of nozzles through which ink is discharged are aligned in a paper width direction, is provided in each of the heads. With this, by discharging ink from each of the heads toward the roll paper S transported in the transport direction, it is possible to form a paper width's worth of dots on the roll paper S at a time. In this manner, the printing section 12 prints the label image by discharging ink from each of the heads on the roll paper S transported in the transport direction.

The test section 13 is a section configured to test a label image formed on the roll paper S. The test section 13 of this embodiment has a scanner 131. As shown in FIG. 2, the scanner 131 is disposed downstream from the heads of the printing section 12 in the transport direction.

The scanner 131 scans the roll paper S on which printing has been performed so as to obtain color information therefrom. Through this, the scanner 131 generates a scan image obtained by scanning the label image printed on the roll paper S.

Subsequently, the test section 13 compares the scan image generated by the scanner 131 with the original image (image data) to test whether or not the label image was normally printed (that is, whether the image is non-defective or defective).

The transport section 14 is a section that includes a feed-out shaft 141 and a winding drive shaft 142 and is so configured as to transport the roll paper S in a predetermined direction (hereinafter, referred to as “transport direction”).

The feed-out shaft 141 is a shaft that is so configured as to feed out the roll paper S in the transport direction and is disposed at the most upstream position in the transport direction in a transport path shown in FIG. 2.

The winding drive shaft 142 is disposed at the most downstream position in the transport direction in the transport path shown in FIG. 2, and is rotated by a motor (not shown) being driven so as to transport the roll paper S in the transport direction as well as wind up the roll paper S on which the label images have been formed.

The print controller 15 is so configured as to control operation of each of the sections in the print device 10. The print controller 15 includes a CPU, a memory, and so on (not shown). The CPU executes a program (which includes various drivers' processes) that drives the respective sections of the print device 10. The memory stores the program to be executed by the CPU and various types of data.

The print controller 15 (which corresponds to the aforementioned controller) controls each of the sections of the print device 10 by making the CPU execute the program stored in the memory. The print controller 15 controls first the transport section 14 to rotate the winding drive shaft 142 using the motor (not shown) so that the roll paper S is transported in the transport direction, during which the print controller 15 controls the printing section 12 and the test section 13, respectively, so as to carry out the printing of the label images. Operation of the printing will be described in detail later.

### Configuration of Post-process Device 20

The post-process device 20 includes a cutting section 21, an unused portion remover 22, and a cut controller 23. Further, the post-process device 20 includes a cut path generator (not shown) that generates a cut-line (hereinafter, also referred to as “cut path”) which is used when the seal member 6 of the roll paper S is cut in the cutting section 21. In the case where the data for cutting obtained in the print job is used as is, it is unnecessary for the cut path generator to generate the cut path.

The cutting section 21 is a section configured to cut the seal member 6 of the roll paper S following the cut path. The cutting section 21 of this embodiment includes a laser cutter (not shown) for cutting the seal member 6 by irradiating the seal member 6 with a laser beam and an eye mark sensor (not shown) for detecting an eye mark printed on the roll paper S. The eye mark is a mark that is used to control the timing when cutting is performed by the laser cutter.

The unused portion remover 22 is so configured as to remove an unnecessary portion (portion other than the label image) of the seal member 6 from the mount 5 of the roll paper S.

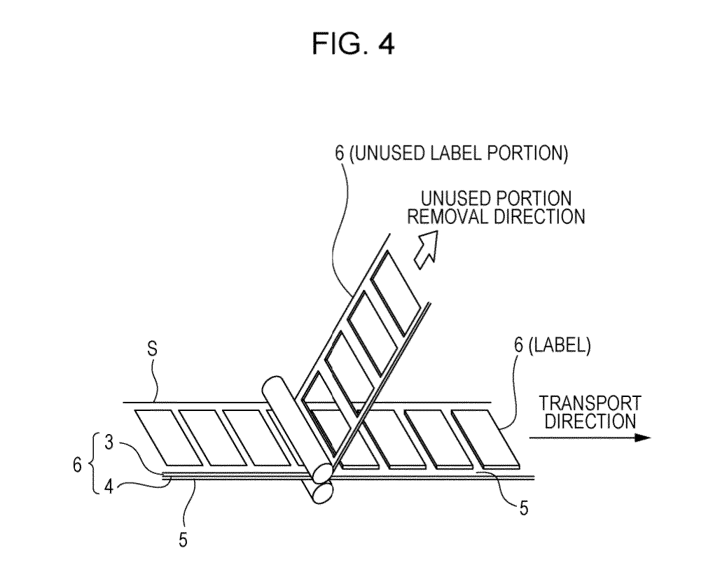

FIG. 4 is a descriptive diagram illustrating an example of a state in which the unused portion removal is being carried out. In this example, label images each being shaped in a substantially rectangular form are printed on the roll paper S, and the perimeter of each of the label images is cut by the laser cutter in the cutting section 21. As shown in the drawing, an unnecessary portion of the seal member 6 (portion other than the label image) of the roll paper S having experienced the cutting is separated from the mount 5 so that only a portion of the seal member 6 that includes the label image is left on the mount 5.

The cut controller 23 is a controller that controls the cutting section 21 and the unused portion remover 22 to make them perform the cutting and unused portion removal respectively in accordance with a command from the job controller.

### Label Image Printing Operation of Print Device 10

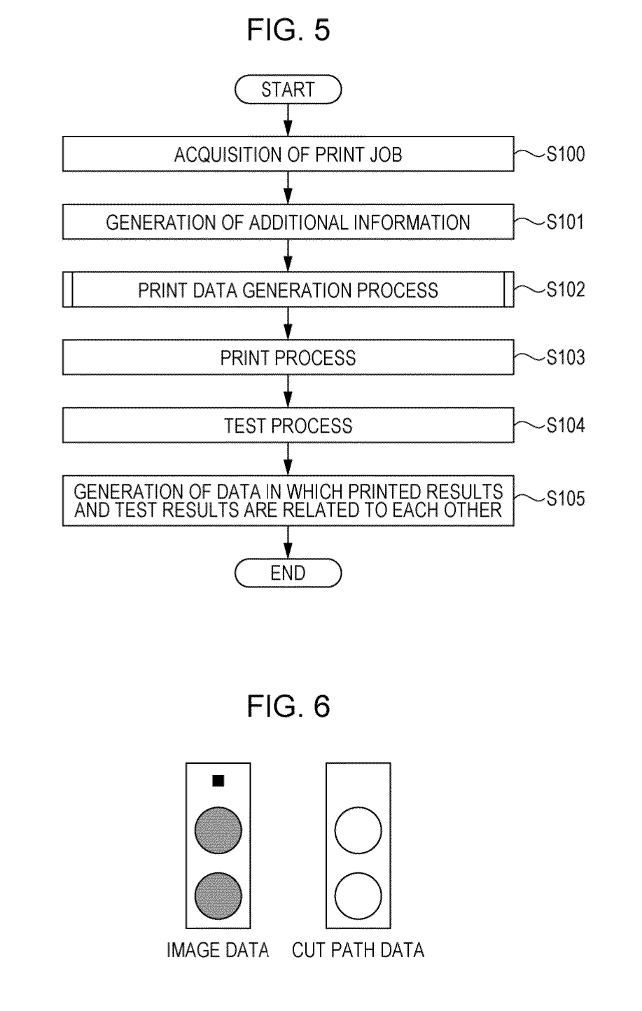

FIG. 5 is a flowchart illustrating a label image printing operation of the print device 10.

First, an operator in charge of operating the label production apparatus 1 inputs a print job into the job controller 30 using an input device (not shown).

FIG. 6 is a descriptive diagram of data obtained in the print job of this embodiment. In this embodiment, as shown in FIG. 6, image data for printing an eye mark and a label image portion is obtained as a print job. Image data used for repeatedly printing two circular images (label images) as shown in the drawing is obtained in this embodiment. In the following description, of the two label images shown in FIG. 6, the one near the eye mark (on the upper side in the drawing) is called a label image in the upper stage, while the other one far from the eye mark (on the lower side in the drawing) is called a label image in the lower stage. Note that each of the above data is bitmap data.

Furthermore, cut path data for cutting the perimeter of the label image portion (cut path of non-defective printing) is also obtained as part of the print job. The cut path data may be generated in the cut controller 23 of the post-process device 20 based on the print data.

The job controller 30 sends the image data of the print job to the print device 10, whereby the print device 10 acquires the print job (image data) (S100).

Upon acquiring the image data, the print controller 15 generates additional information (which corresponds to the aforementioned identification information) for each of the label images (FIG. 5: S101) and adds the generated information to the image data. In this embodiment, a mark including the additional information (QR code (registered trademark)) is added to each label image. Although the print controller 15 adds the QR code to the label image in this embodiment, the invention is not limited thereto; for example, the job controller 30 may add the QR code instead.

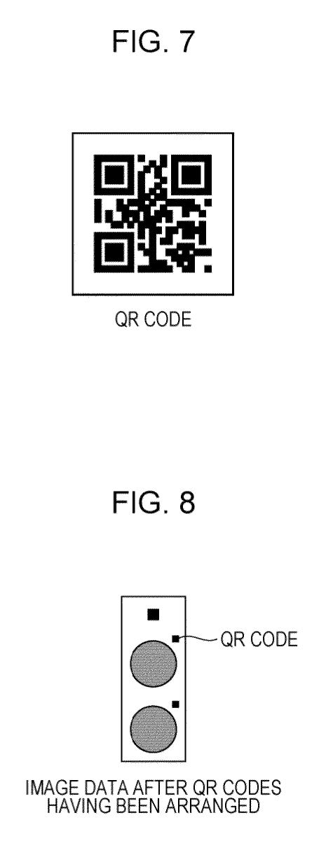

FIG. 7 is a descriptive diagram illustrating an example of a QR code to be added to image data.

In this embodiment, the QR code includes additional information (serial number) to identify each label image.

FIG. 8 is a descriptive diagram of image data to which QR codes are added. In this embodiment, as shown in the drawing, each QR code is arranged at a position on the upper right of each of the label images. Note that, in this embodiment, although the operator specifies where to arrange the QR code with respect to the label image, the invention is not limited thereto. For example, it may be predetermined that the QR code is arranged at a position on the upper right of each label image. However, the position of the QR code is not limited to the position on the upper right of the label image. For example, the QR code may be arranged at a position on the lower left thereof.

The print controller 15 controls the print data generator section 11 to carry out a print data generation process using the image data in which the QR codes have been arranged (FIG. 5: S102)

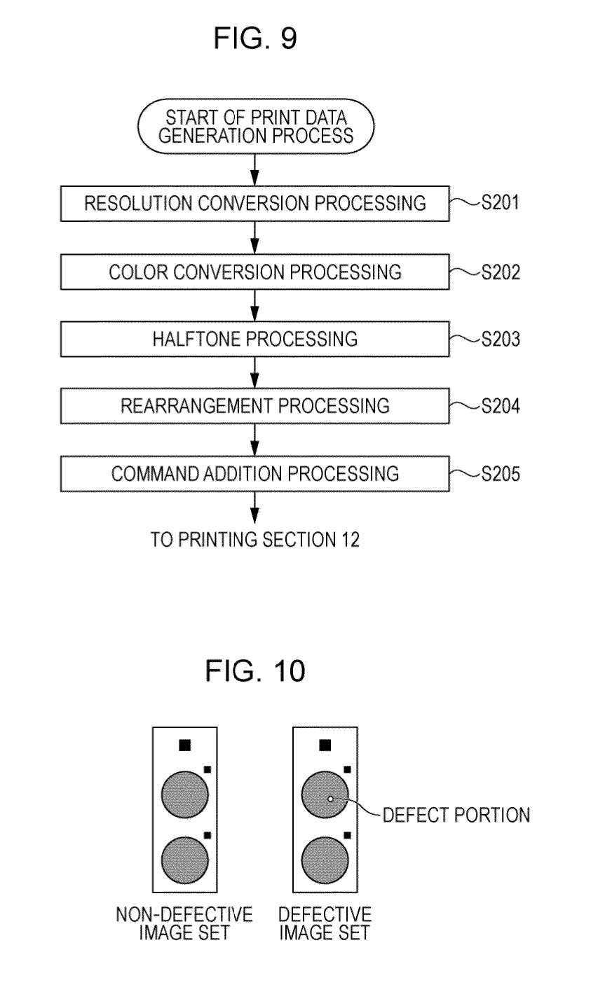

FIG. 9 is a descriptive diagram of the print data generation process.

The print data generator section 11 receives the image data from the print controller 15, converts the received image data to print data in a form that can be interpreted by the printing section 12, then outputs the print data to the printing section 12. The print data generator section 11, when converting the image data to the print data, executes resolution conversion processing, color conversion processing, halftone processing, rearrangement processing, command addition processing, and so on.

The resolution conversion processing (S201) is processing in which the image data (text data, image data, and the like) is so converted as to have resolution (print resolution) with which printing is performed on paper. For example, in the case where print resolution of 720 by 720 dpi is specified, the image data is converted to bitmap-formed image data having resolution of 720 by 720 dpi. Each pixel data of the image data having experienced the resolution conversion processing is multi-tone RGB data expressed in an RGB color space (for example, 256 tones). The tone value is determined based on the RGB image data.

The color conversion processing (S202) is processing that converts the RGB data to data in a CMYK color space. The image data in the CMYK color space is data corresponding to colors of ink that the printing section 12 has. In other words, the print data generator section 11 creates image data on a CMYK plane based on the RGB data.

The color conversion processing is executed based on a table in which tone values of the RGB data are related to tone values of the CMYK data. This table is called a color conversion lookup table (LUT). Note that the pixel data having experienced the color conversion processing is CMYK data of 256 tones expressed in the CMYK color space.

The halftone processing (S203) is processing that converts data of a high-tone number to data of a tone number which can be formed by the printing section 12. With this halftone processing, data indicating 256 tones is converted to one-bit data indicating two tones, two-bit data indicating four tones, or the like. One-bit pixel data or two-bit pixel data corresponds to each pixel of the image data that has experienced the halftone processing. The above pixel data is data indicating a state of dot formation at each pixel (presence/absence of dots, sizes of dots). In the case of the two-bit pixel data (four tones), for example, the pixel data is converted to four levels of dot formation; that is, no dot is formed corresponding to a dot tone value “00”, a small dot is formed corresponding to a dot tone value “01”, a medium dot is formed corresponding to a dot tone value “10”, and a large dot is formed corresponding to a dot tone value “11”. Thereafter, a dot formation ratio for each dot size is determined, then the pixel data is created, making use of dithering, γ correction, an error diffusion method, or the like, so that the dots are formed being dispersed by the printing section 12.

The rearrangement processing (S204) is processing in which the pixel data arranged in matrix form are rearranged in the order of data to be sent to the printing section 12 for each pixel data. For example, the pixel data are so rearranged as to correspond to the arrangement order of the nozzles of each head.

The command addition processing (S205) is processing that adds command data to the data having experienced the rearrangement processing in accordance with the print technique. As the command data, transport data indicating a transport speed of the medium can be cited, for example.

Through experiencing the above-described processings, the print data of CMYK colors is generated from the image data. The generated print data is sent to the printing section 12.

While controlling the transport section 14 to transport the roll paper S in the transport direction, the print controller 15 controls the printing section 12 to discharge ink from the respective heads thereof onto the roll paper S using the print data (respective CMYK print data) generated in the print data generator section 11. In this manner, a print process in which the images shown in FIG. 8 are printed on the roll paper S is carried out (FIG. 5: S103). By consecutively carrying out this print process, the images shown in FIG. 8 are repeatedly printed on the roll paper S.

Subsequently, the print controller 15 controls the test section 13 to carry out a test process in which the label images printed on the roll paper S are tested (FIG. 5: 104). First, the print controller 15 makes the scanner 131 scan the image printed on the roll paper S when the image passes under the scanner 131. Then, the test section 13 tests the presence/absence of defects by comparing the scanned image data (scan data) with the image data (FIG. 8). More specifically, the test section 13 compares the scan data with the original image data for each pixel. If a difference in pixel color is less than a threshold, “OK” is determined; if the difference is equal to or greater than the threshold, “NG” is determined. In this manner, it is tested whether the printed image is non-defective or defective.

FIG. 10 illustrates diagrams as examples of test results. The diagram on the left side in FIG. 10 shows a scan result of a non-defective image set. In this diagram, because there is not any portion where a difference in color exceeds the threshold when compared with the image data (FIG. 8) for each pixel, the image set is determined to be non-defective. Meanwhile, the diagram on the right side in FIG. 10 shows an example of a scan result of a defective image set. In this diagram, there is a portion where a dot is not formed (defect portion) due to a nozzle missing or the like. Therefore, because a portion where a difference in color exceeds the threshold is found when compared with the image data (FIG. 8) for each pixel, the image set is determined to be defective.

Thereafter, the print controller 15 generates data (hereinafter, also referred to as “linkage data”) in which related to each other are the additional information (serial numbers) and the test results by the test section 13 (FIG. 5: S105). In this embodiment, the print controller 15 generates a csv file in which related to each other are the numbers included in the QR codes of the respective label images (serial numbers) and the corresponding test results. Subsequently, the print controller 15 sends the generated csv file to the job controller 30.

Then, the printing of the label images is ended.

### Operation of Post-process Device 20 for Label Image

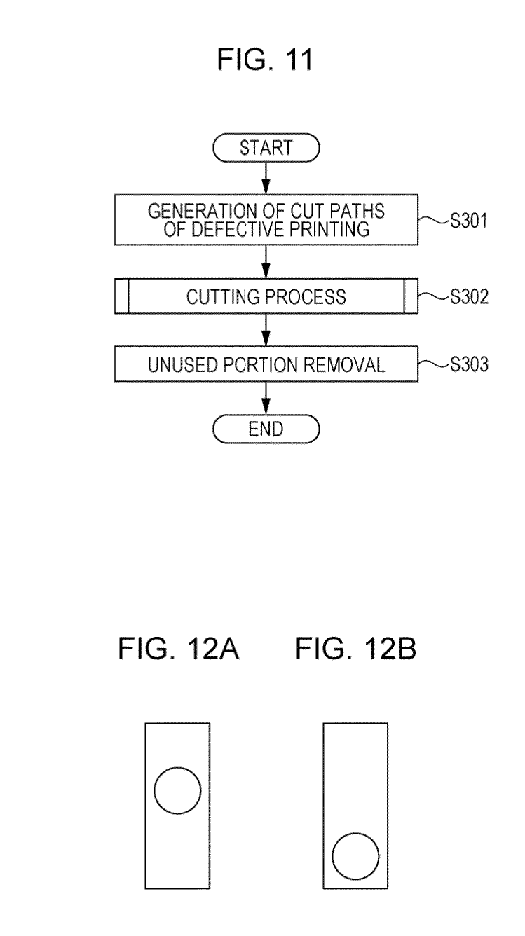

FIG. 11 is a flowchart for describing operation of the post-process device 20. It is assumed that the same transport section as that of the print device 10 is also provided (not shown) in the post-process device 20, and that the roll paper S on which the printing has been performed in the print device 10 is mounted therein.

First, the job controller 30 sends information about the cutting obtained in the print job (cut path data shown in FIG. 6), arrangement positions of the QR codes, and the like to the post-process device 20.

The cut controller 23 generates cut path data of defective printing based on the cut path data shown in FIG. 6 (S301).

FIGS. 12A and 12B are descriptive diagrams of cut path data of defective printing generated in this embodiment. As shown in the drawings, the cut path data of defective printing is such data that prevents either one of the two cut paths shown in FIG. 6 from being cut. Note that FIG. 12A illustrates a cut path of a case in which a label image in the lower stage has a print defect, while FIG. 12B illustrates a cut path of a case in which a label image in the upper stage has a print defect.

Next, the cut controller 23 makes the cutting section 21 carry out a cutting process every time an eye mark is detected, while making the transport section (not shown) transport the roll paper S in the transport direction (FIG. 11: S302). Details of the cutting process will be given later.

Further, the cut controller 23 controls the unused portion remover 22 to separate (remove), from the mount 5, an unnecessary portion of the seal member 6 of the roll paper S that has experienced the cutting (FIG. 11: S303).

As described above, the post-process device 20 carries out the post-process (cutting and unused portion removal) on the roll paper S on which the label images have been printed.

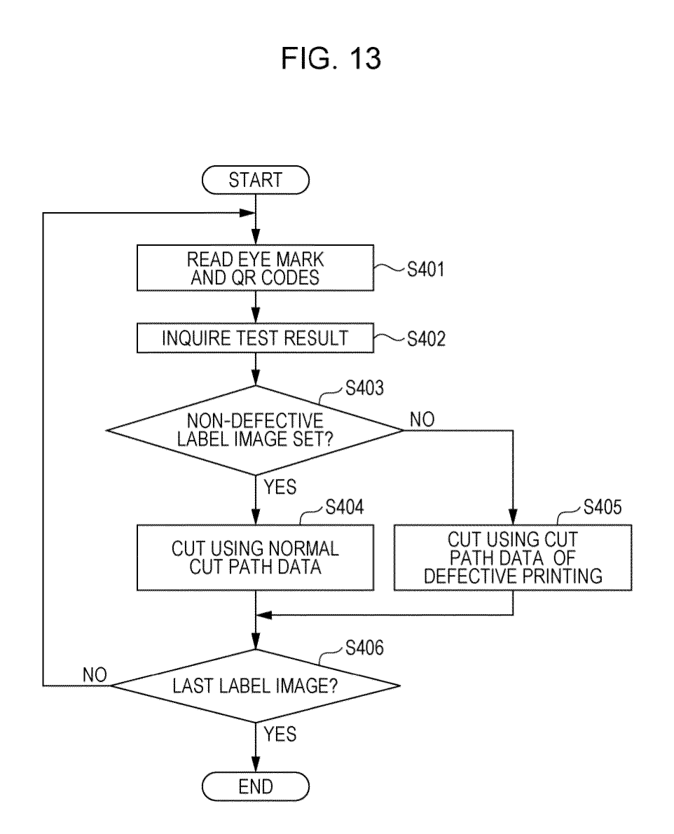

FIG. 13 is a flowchart for describing the cutting process.

The cut controller 23, while controlling the transport section (not shown) to transport the roll paper S in the transport direction, makes the sensor (not shown) of the cutting section 21 read an eye mark and QR codes printed on the roll paper S (S401). The cut controller 23 recognizes cut timing and serial numbers of the label images (serial numbers of two label images in this case) from a result of the reading. Subsequently, the cut controller 23 inquires a test result of the job controller 30 (S402), then determines whether or not the test result related to the serial numbers of the label images indicates a non-defective label image set (S403). In the case of a non-defective image set (“YES” at S403), cutting is performed using normal cut paths (FIG. 6). Meanwhile, in the case of a defective label image set (“NO” at S403), cutting is performed using a cut path of defective printing (see FIGS. 12A and 12B) in accordance with a position of the label image having a print defect (S405). In this case, if both the images in the upper stage and the lower stage have a print defect, neither the upper stage nor the lower stage is cut.

Thereafter, the cut controller 23 determines whether or not the current label image is the last one (S406). If it is determined that the current label image is not the last one (“NO” at S406), the process returns to step S401 so as to carry out the cutting process again. If the current label image is determined to be the last one (“YES” at S406), the cutting process is ended.

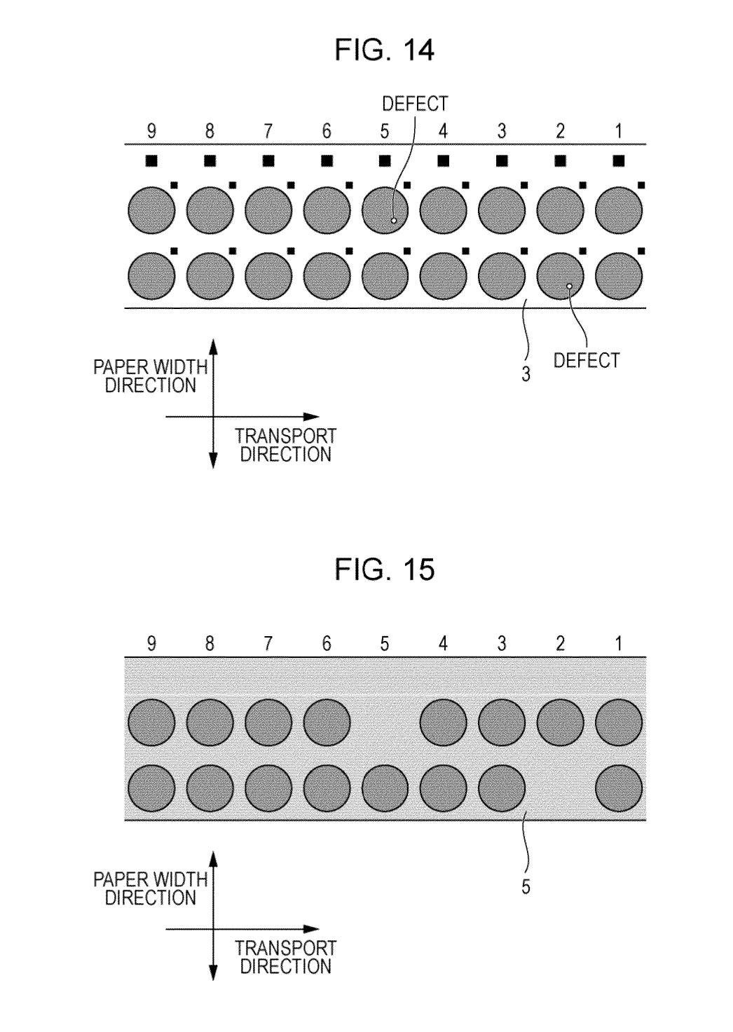

FIG. 14 is a diagram illustrating an example of label images printed by the print device 10. FIG. 15 is a diagram illustrating a state after the cutting and the unused portion removal have been performed on the images shown in FIG. 14 by the post-process device 20. In FIGS. 14 and 15, a number (row number) is given to each print operation (print image) of the image data shown in FIG. 8 in series from the downstream side in the transport direction. Further, as described earlier, of the two label images of each row, the one near the eye mark is called a label image in the upper stage while the other one far from the eye mark is called a label image in the lower stage. For example, in FIG. 14, of the images of the second row, an image in the lower stage is defective. In addition, of the images of the fifth row, an image in the upper stage is defective. Accordingly, in the linkage data (csv file) stored in the job controller 30, the serial number of the image in the lower stage of the second row and the serial number of the image in the upper stage of the fifth row are each indicated as being of a defectively printed image.

When the cutting is performed in the post-process device 20, the cut controller 23 references the linkage data in the job controller 30. For example, in the linkage data generated from the printed label images shown in FIG. 14, because two label images of the first row are indicated as being non-defective, it can be understood that the label images of the first row are free of print defects by referencing the linkage data. Accordingly, normal cut paths (see FIG. 6) are used when the first row is cut. Through this, the two label images are allowed to remain on the mount 5 after the unused portion removal. Meanwhile, as for the second row, the serial number of the label image in the lower stage is indicated as being of a defectively printed image. Accordingly, it can be understood that the label image in the lower stage is defectively printed by referencing the linkage data. Therefore, when the second row is cut, the cut path that prevents the label image in the lower stage from being cut (FIG. 12A) is used. Through this, after the unused portion removal, the image in the upper stage is allowed to remain on the mount 5, as shown in FIG. 15. Similarly, as for the fifth row, referencing the linkage data makes it possible to understand that the label in the upper stage is defectively printed. Therefore, when the fifth row is cut, the cut path that prevents the label image in the upper stage from being cut (FIG. 12B) is used. Through this, after the unused portion removal, the label image in the lower stage is allowed to remain on the mount 5, as shown in FIG. 15. In the case of a row in which both label images in the upper and lower stages have a print defect, the entirety of the row is not cut.

As has been described thus far, the label production apparatus 1 according to this embodiment includes the printing section 12 configured to print label images on the roll paper S using image data for generation of the label images, the test section 13 configured to test the label images printed on the roll paper S, and the print controller 15 configured to control the printing section 12 and the test section 13.

The print controller 15 adds a QR code including additional information (serial number) of each label image to the image data so as to make the printing section 12 print the label image as well as the QR code corresponding to the stated label image, and generates linkage data in which related to each other are test results of the label images by the test section 13 and serial numbers of the label images.

Through this, it is possible to easily determine whether each of the plurality of label images is non-defective or defective by reading the QR codes and referencing the linkage data. Accordingly, it is possible to determine with ease whether or not each of the label images is non-defective.

### Second Embodiment

Note that in the first embodiment, it is not specifically referred to where the print device 10 and the post-process device 20 are installed. In a second embodiment of the invention, the print device 10 and the post-process device 20 are installed at different locations physically remote from each other. Further, the print device 10 and the post-process device 20 are connected with communication lines such as the Internet. Since the configurations of the print device 10 and the post-process 20 are the same as those of the first embodiment, descriptions thereof are omitted.

The job controller 30 of the second embodiment is configured as a web service (cloud service including a storage function) installed on the cloud (a server communicably connected via networks).

In the first embodiment, as identification information to be included in a QR code, a number assigned to each label image is simply added. Meanwhile, in the second embodiment, URL information such as the one shown below is given to the QR code, for example. http://aaa.bbb.ccc.com/search?jobid=Job1&page=PAGE_NUMBER

Here, like in the first embodiment, a serial number is given to PAGE_NUMBER.

In a database (which corresponds to the data storage region) of the job controller 30, stored is data (linkage data) in which the serial numbers and the test results by the test section 13 of the print device 10 are related to each other.

The cut controller 23 of the post-process device 20, while reading the QR codes printed on the roll paper S and inquiring of the job controller 30, cuts a portion of the seal member 6 where the label image is printed.

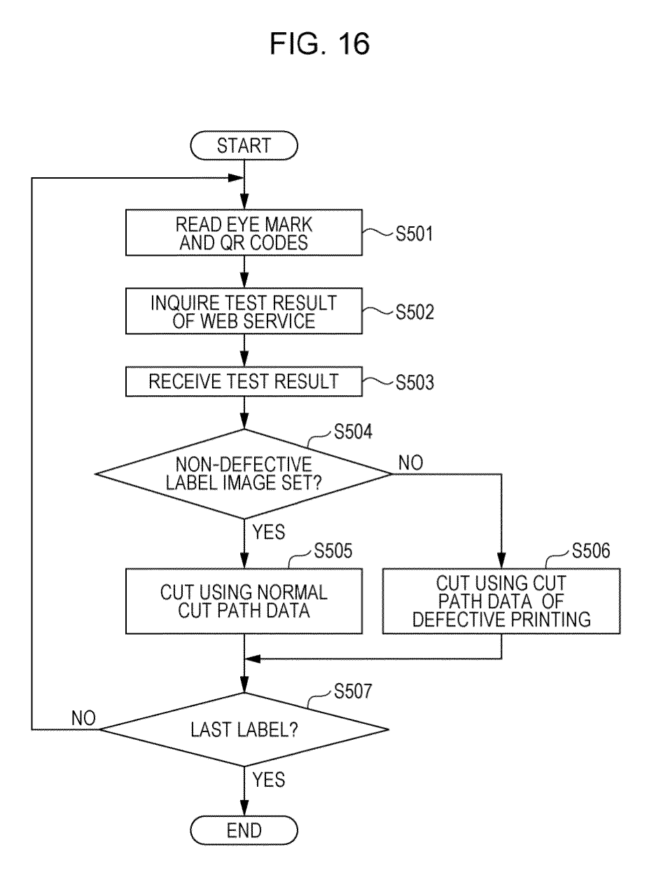

FIG. 16 is a flowchart for describing a cutting process operation of the post-process device 20 of the second embodiment.

First, the cut controller 23, while controlling the transport section (not shown) in the post-process device 20 to transport the roll paper S, makes the sensor (not shown) provided in the cutting section 21 read an eye mark and QR codes printed on the roll paper S (S501). The cut controller 23 recognizes cut timing and serial numbers of the label images. Note that, also in the second embodiment, two label images are printed per eye mark, and the serial numbers of the two label images are read out.

Next, the cut controller 23 inquires a test result of the job controller 30 as a web service on the URL according to the information that has been read out in step S501 (S502).

The job controller 30, in response to the inquiry from the cut controller 23, reads out the data (linkage data) stored in the database and returns the corresponding test result. Through this, the cut controller 23 obtains information on whether the test result of the label images related to the serial numbers indicates a non-defective or defective label image set (S503).

Then, the cut controller 23 determines, from the obtained information, whether or not the two label images as targets to be cut are non-defective (S504). If both the two label images are non-defective (“YES” at S504), a portion of the base material 3 where the label image is printed is cut using normal cat paths (S505). Meanwhile, if a print defect is included in the two label images (“NO” at S504), cutting is performed using a cut path that prevents the label image having the print defect from being cut (S506). For example, in FIG. 14, since the label image in the lower stage of the second row is defectively printed, cutting is performed using the cut path shown in FIG. 12A that prevents the label image in the lower stage from being cut.

Thereafter, the cut controller 23 determines whether or not the current label is the last one (S507). If it is determined that the current label is not the last one (“NO” at S507), the process returns to step S501 so as to carry out the same cutting process again. If it is determined that the current label is the last one (“YES” at S507), the cutting process is ended.

By repeating the above-described operation processes, it is possible to perform the cutting and unused portion removal like in the first embodiment.

In the second embodiment, even if the print device 10 and the post-process device 20 are installed at different locations physically remote from each other, it is possible for the post-process device 20 to determine with ease whether the label images are non-defective or defective.

### Other Embodiments

The above embodiments are given so as to facilitate understanding of the invention, and are not intended to limit the interpretation of the invention. This invention can be modified or improved without departing from the spirit of the invention, and it is needless to say that those equivalent entities are included in this invention. In particular, embodiments described hereinafter may be also included in this invention.

### Printing Section 12

In the above embodiments, although the printing section 12 is a line printer, the invention is not limited thereto. For example, such a printer may be employed as the printing section 12 that has a plurality of heads disposed facing a circumferential surface of a cylindrical transport drum and discharges ink from the heads toward a medium while transporting the medium along the circumferential surface of the transport drum so as to form an image on the medium. In addition, for example, the printing section 12 may be a printer (lateral printer) that repeats operation of discharging ink toward a medium that has been transported to a printing region while moving a head of the printer along a transport direction of the medium as well as operation of moving the head in a width direction of the medium so as to form an image in the printing region, thereafter transports a portion of the print target medium on which printing has not been performed to the printing region.

### Discharge Technique

The technique of discharging ink from a head may be a technique that discharges ink using a piezoelectric element (piezo element) or a technique that discharges ink using bubbles generated by heat in a nozzle. Other techniques may be used as well.

### Medium

Although, as an example of a medium, roll paper S is cited and described in the above embodiments, the invention is not limited thereto. It is sufficient that the medium is formed of three layers including the base material 3, the adhesive layer 4 and the mount 5. For example, the medium may be a cut paper. Further, the materials of the three layers are not limited to any specific ones. The base material 3 may be a film, for example.

### Ink

As inks for color images, although the four color inks of cyan, magenta, yellow, and black are used in the above embodiments, other color inks (for example, light cyan, light magenta, and the like) may be additionally used.

A UV curing ink that hardens when being irradiated with ultraviolet light (UV) may be used. In this case, by providing a light source for emitting UV at the downstream side of each of the heads in a medium transport direction and irradiating a medium with the UV on which dots have been formed, the dots can be fixed on the medium. Accordingly, printing can be favorably performed even on a medium which is unlikely to absorb ink.

### Label Image

Although a circular figure is printed as a label image in the above embodiments, the invention is not limited thereto. Other figures, pictures, symbols (characters), and the like may be printed. Further, in the above embodiments, although two label images are arranged in the paper width direction, the invention is not limited thereto. For example, three or more label images may be arranged being aligned in the paper width direction.

### Test Section 13

Although, in the above embodiments, the scanner 131 is used to test whether or not a label image is non-defective, the invention is not limited thereto. For example, such a technique may be employed that detects a defect portion (ink not being discharged) in real time by an electric signal of residual vibration of the head at a time of ink discharge.

### Post-process Device 20

Although, in the above embodiments, the post-process device 20 includes the cutting section 21 and the unused portion remover 22, the invention is not limited thereto. For example, the unused portion remover may be provided as a separate device (different entity) and may only perform removing an unused portion of the roll paper S that has experienced the cutting.

Further, although, in the above embodiments, the cutting section 21 cuts a portion of the seal member 6 where a label image is printed in the roll paper S by using a laser cutter (not shown), the invention is not limited thereto. For example, a clicker cutter may be used instead.

In the above embodiments, cutting is not performed when a print defect is detected. However, cutting may be performed on a label image having a print defect so that only a QR code is allowed to remain. This makes it possible to easily recognize a portion to which a non-defective label image is pasted in the case where the non-defective label image need be pasted after the unused portion removal has been performed on the defectively printed label image.

### QR Code

In the above embodiments, although the QR code is used as a mark including additional information of a label image, the invention is not limited to the QR code. The mark may be anything as long as it makes it possible to identify a plurality of label images, and may be a numeral value, text, a barcode, or the like, for example. Further, a mark whose color is changed every predetermined set of pages may be used, for example.

The entire disclosure of Japanese Patent Application No. 2013-068829, filed Mar. 28, 2013 is expressly incorporated by reference herein.

What is claimed is:

1. A label production apparatus comprising:
a printing unit configured to print, using image data for generation of a label image, a plurality of the label images on a print target medium;
a test unit configured to test each of the label images printed on the print target medium; and
a controller for controlling the printing unit and the test unit,
wherein the controller adds a mark including identification information of each label image to the image data so as to make the printing unit print the label image as well as the mark corresponding to the label image, and generates linkage data in which related are a test result of the label image by the test unit and the identification information of the label image to each other.

2. The label production apparatus according to claim 1,
wherein the print target medium includes a first base material having a print surface, a second base material, and an adhesive layer interposed between the first base material and the second base material; and
the label production apparatus further includes a post-process unit that is configured to cut the first base material, and in accordance with the linkage data, cuts a portion of the first base material where the label image is printed without any print defect that has been detected whereas does not cut a portion of the first base material where the label image is printed with a print defect that has been detected.

3. The label production apparatus according to claim 1,
wherein the print target medium includes the first base material having the print surface, the second base material, and the adhesive layer interposed between the first base material and the second base material,
the controller stores the linkage date in a data storage region of a server which is communicably connected via networks, and
the linkage data is used when a portion of the first base material of the print target medium where the label image is formed is cut.

4. A label production apparatus comprising:
a post-process unit configured to cut, of a print target material including a first base material having a print surface, a second base material, and an adhesive layer interposed between the first and second base materials, a portion of the first base material where a label image is printed,
wherein a plurality of the label images are printed on the print target medium while a mark including identification information of each label image is added to each of the label images and printed together with the label image; and
the post-process unit, based on linkage data in which a test result of each of the label images and the identification information of each of the label images are related to each other, cuts a portion of the first base material where the label image is printed without any print defect that has been detected whereas does not cut a portion of the first base material where the label image is printed with a print defect that has been detected.

5. The label production apparatus according to claim 4,
wherein the post-process unit obtains the linkage data from a data storage region in a server communicably connected via networks.

6. A label production method comprising:
printing a plurality of label images on a print target medium, using image data for generation of the label image, and adding a mark including identification information of each of the label images to each of the label images while relating each mark to each of the label images so as to print the label image with the mark being added;
testing each of the label images printed on the print target medium; and
generating linkage data in which related are a test result of each of the label images by the testing and the identification information of each of the label images.
